(19) United States
(12) Patent Application Publication
(10) Pub. No.: US 2015/0181036 A1
(43) Pub. Date: Jun. 25, 2015

(54) CONTEXTUALIZED WORD TO TELEPHONE NUMBER MAPPING

(71) Applicant: Google Inc., Mountain View, CA (US)

(72) Inventor: Brandon Stephen WUEST, Redwood City, CA (US)

(21) Appl. No.: 13/904,982

(22) Filed: May 29, 2013

(51) Int. Cl. H04M 3/42

(52) U.S. Cl. CPC H04M 3/42306

(57) ABSTRACT

A contextualized word to telephone number mapping system may include one or more computing devices and a memory. The one or more computing devices may receive a telephone number of a business and terms related to the business. The one or more computing devices may determine whether at least one of the terms can be mapped to the telephone number of the business based at least in part on an alphanumeric-to-numeric mapping. The one or more computing devices may provide at least one of the terms when at least one of the terms can be mapped to the telephone number of the business using the alphanumeric-to-numeric mapping, otherwise the one or more computing devices may provide an available telephone number to which at least one of the terms can be mapped using the alphanumeric-to-numeric mapping.

### TECHNICAL FIELD

The present description relates generally to word to telephone number mappings, and more particularly, but not exclusively, to contextualized word to telephone number mappings.

### BACKGROUND

Businesses may utilize telephone numbers to interact with current or potential customers. In some instances a business may not have a website and therefore the business's telephone number may be its primary channel for interacting with customers. Thus, it may be beneficial for the business to have a telephone number that is easily identifiable and/or memorable for customers, e.g. 123-4567. However, some businesses may have established telephone numbers that they do not wish to change. Furthermore, if a business does not have a website, the business may need to include their telephone number in advertisements, e.g. online advertisements or print advertisements, which may increase the cost of the advertisements and/or may force the business to exclude one or more relevant terms from the advertisements, e.g. due to advertisement size constraints.

### SUMMARY

The disclosed subject matter relates to a computer implemented method for determining contextually relevant terms that can be mapped to a telephone number of a business. The method may include retrieving, using one or more computing devices, telephone numbers of businesses, each business being associated with a business category. The method may further include determining, using the one or more computing devices, a keyword that is associated with the business category. The method may further include determining, using the one or more computing devices and for each business, whether the keyword can be mapped to at least a portion of the telephone number of the business based at least in part on an alphanumeric-to-numeric mapping. The method may further include generating, using the one or more computing devices and for each business for which the keyword can be mapped to the at least the portion of the telephone number of the business, a phoneword for the business by replacing the at least the portion of telephone number of the business with the keyword. The method may further include providing, using the one or more computing devices and to each business for which the keyword can be mapped to at least the portion of the telephone number of the business, the phoneword for the business.

The disclosed subject matter also relates to a computer implemented method for mapping a contextually relevant term to a telephone number. The method may include receiving, using one or more computing devices, an ordered plurality of numbers that are associated with a business. The method may further include determining, using the one or more computing devices, a first category that is associated with the business. The method may further include determining, using the one or more computing devices, a first ordered plurality of alphanumeric characters that are related to the first category and that can be mapped to at least a first portion of the ordered plurality of numbers based at least in part on an alphanumeric-to-numeric mapping. The method may further include providing, using the one or more computing devices, the first ordered plurality of alphanumeric characters.

The disclosed subject matter also relates to a non-transitory machine-readable medium embodying instructions that, when executed by a machine, cause the machine to perform a method for determining contextually relevant terms that can be mapped to a telephone number of a business. The method may include determining a telephone number of a business and a plurality of candidate terms that are contextually relevant to the business, wherein the telephone number comprises an ordered plurality of numbers. The method may further include determining a plurality of terms of the plurality of candidate terms that can be mapped to at least a portion of the ordered plurality of numbers of the telephone number based at least in part on an alphanumeric-to-numeric mapping. The method may further include generating a plurality of phonewords using the plurality of terms and the telephone number, wherein each of the plurality of phonewords comprises the telephone number with the at least the portion of the ordered plurality of numbers being replaced with one of the plurality of terms. The method may further include providing the plurality of phonewords to a device of a user associated with the business.

The disclosed subject matter also relates to a contextualized word to telephone number mapping system. The system may include one or more computing devices and a memory including instructions that, when executed by the one or more computing devices, cause the one or more computing devices to: receive a telephone number of a business and a plurality of terms related to the business, determine whether at least one of the plurality of terms can be mapped to the telephone number of the business based at least in part on an alphanumeric-to-numeric mapping, and provide the at least one of the plurality of terms when the at least one of the plurality of terms can be mapped to the telephone number of the business, otherwise provide an available telephone number to which the at least one of the plurality of terms can be mapped using the alphanumeric-to-numeric mapping.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment that may implement a contextualized word to telephone number mapping system in accordance with one or more implementations.

FIG. 2 illustrates a flow diagram of an example process for a contextualized word to telephone number mapping system in accordance with one or more implementations.

FIG. 3 illustrates a flow diagram of an example process for a contextualized word to telephone number mapping system in accordance with one or more implementations.

FIG. 4 illustrates a flow diagram of an example process for a contextualized word to telephone number mapping system in accordance with one or more implementations.

FIG. 5 illustrates an example alphanumeric-to-numeric mapping for a contextualized word to telephone number mapping system in accordance with one or more implementations.

FIG. 6 conceptually illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In some instances, structures and components are shown in block diagram form in order to avoid obscuring the concepts of the subject technology.

I. Overview

In the subject system for contextualized word to telephone number mapping, terms that are contextually relevant to a business are mapped to the telephone number of the business, e.g. based on the alphanumeric-to-numeric mapping of a telephone keypad. The subject system uses the contextually relevant terms, and the business's telephone number, to generate phonewords for the business. The term “phoneword” as used herein encompasses its plain and ordinary meaning and, if not otherwise included in its plain and ordinary meaning, may also refer to any ordered set of alphanumeric characters that can be mapped to a human interface device that can be used to initiate a telephone call, such as a telephone keypad.

In one or more implementations, a phoneword may be generated using a telephone number and a contextually relevant term by replacing the individual numbers of the telephone number with the mapped alphanumeric characters of the term. For example, the phoneword “111-FOOD” may be generated using the telephone number 111-3663 and the term “food.” The phonewords may allow a business to advertise their existing telephone number to customers in an easily identifiable and/or memorable form. Furthermore, the phonewords may allow a business to advertise their phone number using a contextually relevant term, e.g. a term that may be desirable to include in an advertisement irrespective of the phoneword.

The subject system may determine terms that are contextually relevant to a business by using a set of information related to the business, such as the name of the business, a description of the business, a category associated with the business, or generally any information related to the business. For example, the subject system may retrieve terms that are related to a category associated with the business, such as the term “food” for the category of “restaurant.” Alternatively, or in addition, the subject system may determine the terms based on online queries that resulted in users finding the business and/or a similar business. For example, users may find the business by performing an online query for one or more terms that may not be included in, or otherwise may not be derivable from, the set of information related to the business. In one or more implementations, the subject system may retrieve terms that the business, or a similar business, has pursued with respect to online advertising.

If the subject system is unable to determine any terms that are contextually relevant to the business that can be mapped to the telephone number of the business, the subject system may search for available telephone numbers for which a contextually relevant term can be mapped. In one or more implementations, the subject system may search for available telephone numbers having the same area code as the current telephone number of the business, available telephone numbers having area codes that are used in the geographic region associated with the area code of the current telephone number of the business, and/or any available telephone numbers irrespective of the area codes. The subject system may then provide the business with any available telephone numbers for which a contextually relevant term can be mapped, and/or the corresponding phonewords. The subject system may facilitate the business with activating an available telephone number and forwarding calls from the available telephone number to their current telephone number.

In one or more implementations, the subject system may analyze the telephone numbers of businesses on a periodic basis, such as on a weekly basis. For example, the subject system may maintain lists of terms that are relevant to business categories. The list of terms may change over time as different terms become relevant (or irrelevant) for different categories. Thus, on a periodic basis the subject system may retrieve the telephone numbers of businesses that are associated with a particular category. The subject system may then analyze each telephone number to determine whether any of the list of relevant terms for the category can be mapped to the telephone number. The subject system may notify businesses of any terms that can be mapped to their phone numbers.

After a business has confirmed that they would like to advertise their telephone number using a phoneword, such as a phoneword suggested by the subject system, any online advertisements that include the telephone number of the business may be modified to include the phoneword, e.g. instead of, or in addition to, the telephone number of the business. In the instance that a business is associated with multiple categories, the business may select a different phoneword for each category. Thus, the phoneword used in the business's advertisements may differ depending upon the category for which the advertisement is being retrieved.

In one or more implementations, the alphanumeric-to-numeric mapping used by the subject system may differ based on geographic region. For example, the alphanumeric characters that are associated with a particular number on a telephone keypad in one geographic region may differ from the alphanumeric characters that are associated with the number on a telephone keypad in another geographic region. Thus, the subject system may determine the appropriate alphanumeric-to-numeric mapping based at least in part on a geographic region associated with the telephone number of the business and/or based at least in part on a geographic region where the business intends to advertise a phoneword.

II. Example Network Environments for Contextualized Word to Telephone Number Mapping Systems

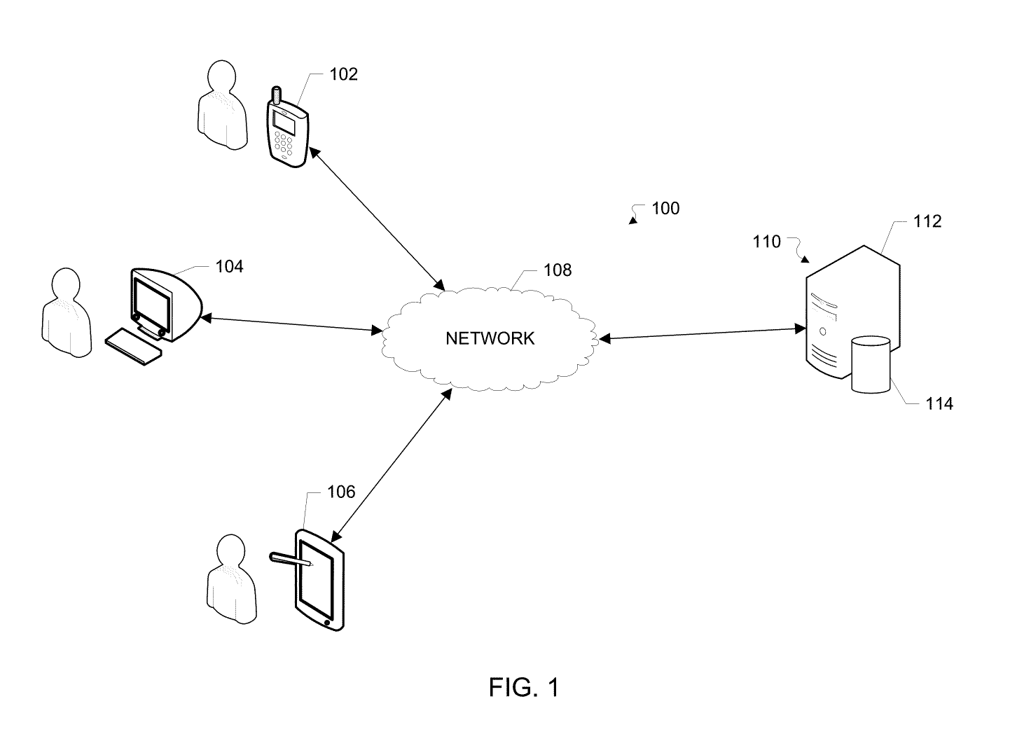

FIG. 1 illustrates an example network environment 100 which may implement a contextualized word to telephone number mapping system in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The example network environment 100 may include a number of electronic devices 102, 104, 106 communicably connected to a server 110, such as by the network 108. In another example, some or all of the electronic devices 102, 104, 106 may be communicably connected to one another, such as by the network 108, and some or all of the electronic devices 102, 104, 106 may not be communicably connected to the server 110. The network 108 may be a public communication network (such as the Internet, cellular data network, dialup modems over a telephone network) or a private communications network (such as private local area network (“LAN”), leased lines). The network 108 may also include, but is not limited to, any one or more of the following network topologies, including a bus network, a star network, a ring network, a mesh network, a star-bus network, a tree or hierarchical network, and the like.

In some example embodiments, the electronic devices 102, 104 and 106 can be computing devices such as laptop or desktop computers, smartphones, personal digital assistants (“PDAs”), portable media players, tablet computers, wearable devices, such as eyeglasses or watches that have one or more processors coupled thereto and/or embedded therein, televisions or other displays with one or more processors coupled thereto and/or embedded therein, or other appropriate computing devices that can be used to for displaying a web page, a web application, a mobile application, or another graphical user interface. In the example of FIG. 1, the electronic device 102 is depicted as a smartphone, the electronic device 104 is depicted as a desktop computer, and the electronic device 106 is depicted as a tablet device.

In one example, server 110 may be a single computing device such as a computer server. In another example, server 110 may represent one or more computing devices (such as a cloud of computers and/or a distributed system) that are communicatively coupled, such as communicatively coupled over the network 108, that collectively, or individually, perform one or more functions that can be performed server-side, such as search result retrieval, advertising content retrieval, advertising content serving, determining terms relevant to a business or to a category to which the business is associated, determining contextually relevant phonewords for a business, and/or generally any functions that can be performed server-side. The one or more computing devices of the server 110 may be geographically collocated and/or the one or more computing devices of the server 110 may be disparately located. The server 110 may be coupled with various databases, storage services, or other computing devices. The server 110, and the coupled databases, storage services, or other computing devices may be geographically collocated, or may be disparately located.

In one or more implementations, the server 110 includes a processing device 112 and a data store 114. The processing device 112 executes computer instructions stored in the data store 114, for example, to determine a contextually relevant term that can be mapped to a telephone number of a business. In one or more implementations, the data store 114 may store the computer instructions on non-transitory computer-readable medium.

The server 110 may host a web server that is communicatively coupled to client devices, such as web browsers and or web-based applications of client devices (e.g., electronic devices 102, 104 or 106) via network 108. In one example, the subject system may be integrated into one or more of a search engine, a map engine, an advertising content retrieval system and/or an advertising content serving system hosted at server 110. In another example, the subject system may be hosted at server 110 and may be communicatively coupled to one or more remote servers hosting one or more other search engines, map engines, advertising content retrieval systems and/or advertising content serving systems (e.g., one or more remote servers) over one or more networks (e.g., network 108).

III. Example Processes for Contextualized Word to Telephone Number Mapping Systems

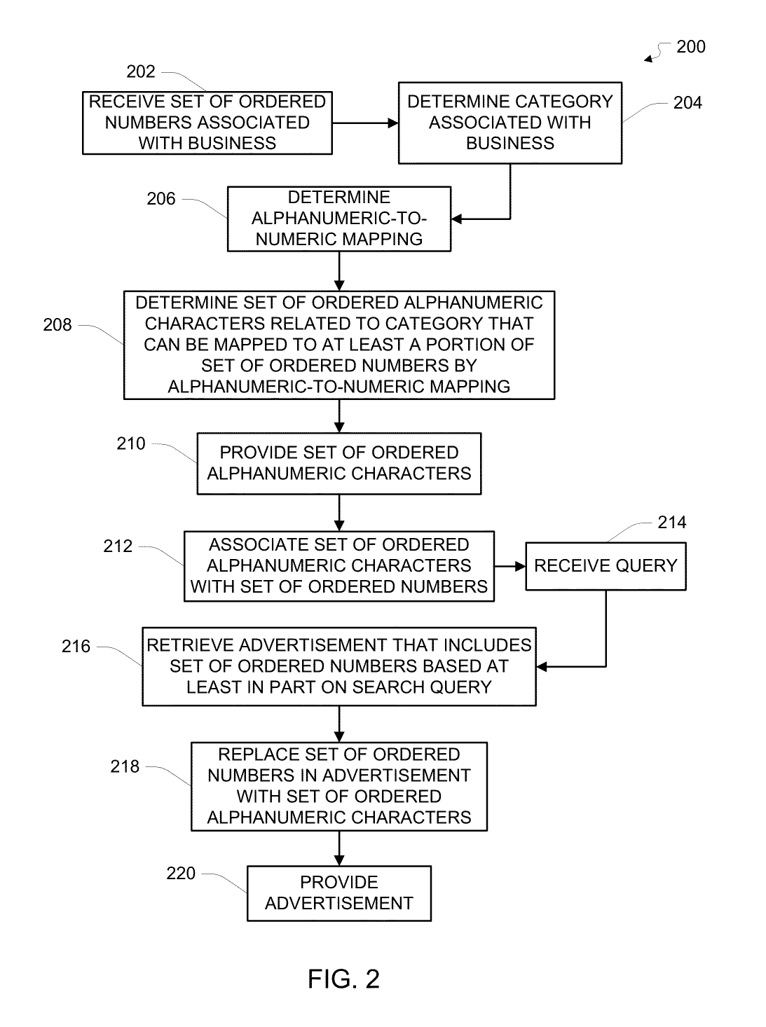

FIG. 2 illustrates a flow diagram of example process 200 for contextualized word to telephone number mapping in accordance with one or more implementations. For explanatory purposes, example process 200 is described herein with reference to example network environment 100 of FIG. 1; however, example process 200 is not limited to example network environment 100 of FIG. 1. Further for explanatory purposes, the blocks of example process 200 are described herein as occurring in serial, or linearly. However, multiple blocks of example process 200 may occur in parallel. In addition, the blocks of example process 200 need not be performed in the order shown and/or one or more of the blocks of example process 200 need not be performed.

In block 202, the server 110 receives an ordered set of numbers that are associated with a business, such as a telephone number associated with the business. For example, a user that is associated with the business, such as an employee or owner of the business, may interact with the electronic device 102 to provide an ordered set of numbers to the server 110, e.g. via network 108. Alternatively, or in addition, the server 110 may retrieve the ordered set of numbers from a third party server, e.g. over the network 108 or from a memory, such as data store 114. The phrase “ordered set of numbers” or “ordered plurality of numbers” as used herein encompasses its plain and ordinary meaning and, if not otherwise included in its plain and ordinary meaning, may also refer to any group or of set of numbers that are associated with a sequential order, such as a telephone number.

In block 204, the server 110 determines one or more categories that are associated with the business. The one or more categories may relate to differentiable aspects of the business that may be used to categorize the business, such as a type of the business. For example if the business is an Italian restaurant that serves pizza, a category associated with the business may be one or more of: restaurant, Italian restaurant, Italian restaurant that serves pizza, or generally any aspect of the business that may be used to categorize the business. In one or more implementations, the user that is associated with the business may interact with the electronic device 102 to indicate one or more categories that are associated with the business. Alternatively, or in addition, the server 110 may retrieve one or more categories that are associated with the business from a memory, such as data store 114. In one or more implementations, the server 110 may determine one or more categories that are associated with the business by comparing one or more determinable characteristics of the business with characteristics that are associated with existing categories and/or characteristics of business that have been categorized in accordance with existing categories. For example, if the name of the business includes the word “pizza,” the server 110 may determine that a category of “pizza restaurant” should be associated with the business.

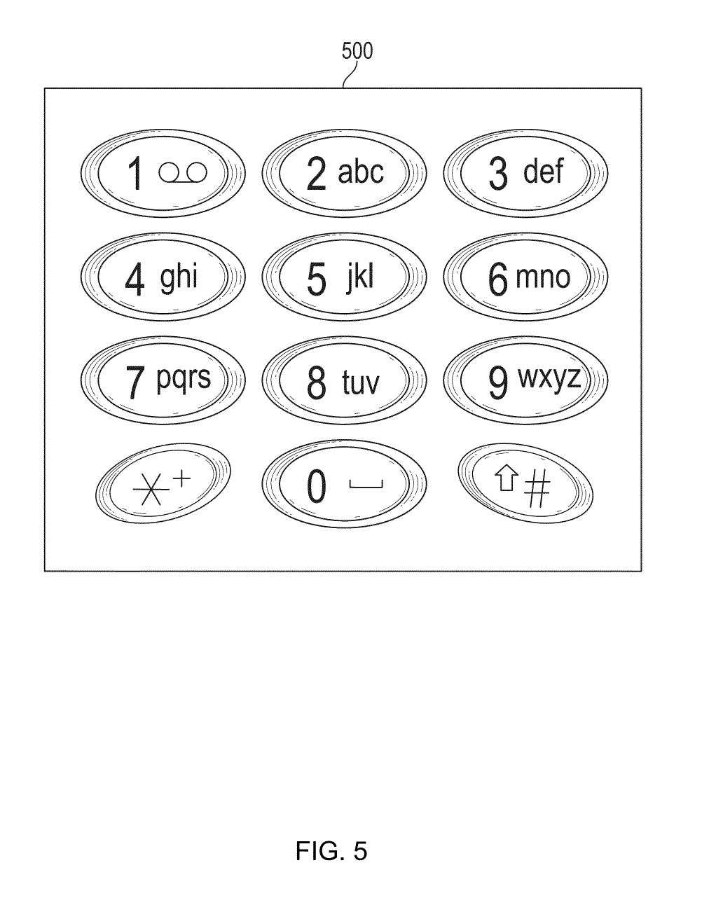

In block 206, the server 110 determines an alphanumeric-to-numeric mapping that is suitable for mapping alphanumeric characters to the ordered set of numbers, such as the alphanumeric-to-numeric mapping of a telephone keypad when the ordered set of numbers is a telephone number. An example alphanumeric-to-numeric mapping of a telephone keypad is discussed further below with respect to FIG. 5. If the ordered set of numbers is a telephone number associated with the business, the server 110 may determine the alphanumeric-to-numeric mapping based at least in part on a geographic region associated with the telephone number of the business, e.g. based on the country code and/or area code of the telephone number, and/or based at least in part on a geographic region where the business is advertising the telephone number, and/or intends to advertise an ordered set of alphanumeric characters that are mapped to the telephone number.

In block 208, the server 110 determines an ordered set of alphanumeric characters related to the category that can be mapped to the ordered set of numbers associated with the business. For example, the server 110 may identify or retrieve, e.g. from the data store 114, one or more terms that are associated with the category. In one or more implementations, the terms associated with the category may be terms that relate to the businesses associated with the category, such as the term “food” for the category of “restaurant.” Alternatively, or in addition, the server 110 may determine and/or retrieve one or more online queries that resulted in users finding the businesses associated with the category. For example, users may find the businesses associated with the category by performing an online query for one or more terms. The server 110 may then determine at least one term that can be mapped to at least a portion of the ordered set of numbers associated with the business.

In block 210, the server 110 provides the ordered set of alphanumeric characters of the at least one term determined in block 208. For example, the server 110 may provide, for display, the ordered set of alphanumeric characters to an electronic device 102 that is being interacted with by a user that is associated with the business (e.g., the user may be a public relations (PR) professional for the business and/or an advertising consultant for the business). In block 212, the server 110 may associate the ordered set of alphanumeric characters with the ordered set of numbers associated with the business, e.g. in response to receiving a request therefor from the user associated with the business via the electronic device 102. For example, the server 110 may store an association between the ordered set of numbers associated with the business and the ordered alphanumeric characters in the data store 114.

In block 214, the server 110 receives a query, such as from a user interacting with an electronic device 104. For example, the received query may relate to a search for the business. In block 216, the server 110 retrieves an advertisement for the business that includes the ordered set of numbers based at least in part on the search query. For example, the business may have keyed the advertisement to the query that was received by the server 110 in block 214. In one or more implementations, the server 110 may retrieve an advertisement for the business that does not include the ordered set of numbers.

In block 218, the server 110 replaces the ordered set of numbers in the advertisement with the ordered set of alphanumeric characters that is associated with the ordered set of numbers. If the advertisement for the business does not include the ordered set of numbers, the server 110 may append the set of alphanumeric characters to the advertisement. In block 220, the server 110 provides the advertisement, e.g. for display to the electronic device 104 being interacted with by the user who provided the query (e.g. in block 214).

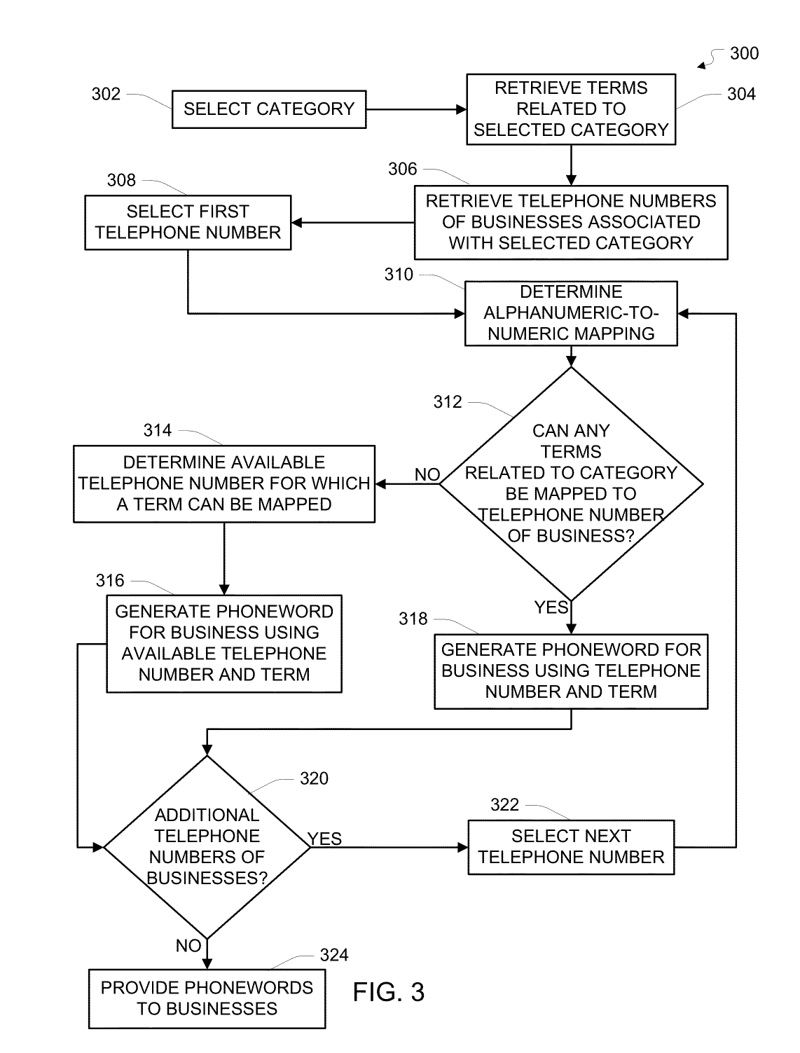

FIG. 3 illustrates a flow diagram of example process 300 for contextualized word to telephone number mapping in accordance with one or more implementations. For explanatory purposes, example process 300 is described herein with reference to example network environment 100 of FIG. 1; however, example process 300 is not limited to example network environment 100 of FIG. 1. Further for explanatory purposes, the blocks of example process 300 are described herein as occurring in serial, or linearly. However, multiple blocks of example process 300 may occur in parallel. In addition, the blocks of example process 300 need not be performed in the order shown and/or one or more of the blocks of example process 300 need not be performed.

In block 302, the server 110 selects a category, e.g. from the data store 114. For example, the server 110 may manage, and/or have access to, categories that are associated with businesses, such as businesses that are listed in an online business listing service or an online map service. In block 304, the server 110 retrieves terms, or keywords, that are related to the selected category, such as from the data store 114. For example, the server 110 may identify queries that businesses associated with the category have focused advertisements on, queries that were performed by users that found businesses associated with the category through an online search or online map service, terms that were provided by businesses associated with the category, e.g. descriptive terms, terms that are determinable from information provided by businesses associated with the category, and/or terms that are determinable from online presences of businesses associated with the category, e.g. web pages, news feeds, etc.

In block 306, the server 110 retrieves the telephone numbers of the businesses that are associated with the selected category. In block 308, the server 110 selects the first telephone number of a business from the retrieved telephone numbers. In block 310, the server 110 determines an alphanumeric-to-numeric mapping, e.g. based at least in part on the geographic region associated with the selected telephone number (e.g. in block 308). In block 312, the server 110 determines whether any of the terms related to the category (e.g. retrieved in block 304) can be mapped to at least a portion of the selected telephone number of the business. If, in block 312, the server 110 determines that none of the terms related to the category can be mapped to the selected telephone number, the server 110 moves to block 314.

In block 314, the server 110 determines an available telephone number for which a keyword can be mapped. In one or more implementations, an available telephone number may be a telephone number that is not in use and that could be procured by the business. For example, the server 110 may have access to a list of available telephone numbers, e.g. stored in data store 114, and/or the server 110 may receive a list of available telephone numbers, e.g. from a third party server. The server 110 may identify at least one of the available telephone numbers for which at least one of the terms can be mapped. In one or more implementations, the server 110 may identify available telephone numbers that have the same area code as the selected telephone number, or telephone numbers that have an area code that is associated with the same geographic region as the area code of the selected telephone number.

In block 316, the server 110 generates a phoneword for the business associated with the selected telephone number using the available telephone number and the term that can be mapped to the available telephone number. The server 110 may store an association between the business and the phoneword, e.g. in the data store 114. The phoneword may be the telephone number with the respective numbers to which the letters of the term are mapped being replaced with the letters of the term. For example, the telephone number 749-924-4444 may be mapped to PIZZA-44444, PIZ-ZA4-4444, or any derivation thereof.

If, in block 312, the server 110 determines that at least one of the terms related to the category can be mapped to the selected telephone number, the server 110 moves to block 318. In block 318, the server 110 generates a phoneword for the business associated with the selected telephone number using the selected telephone number and the at least one term related to the category that can be mapped to the selected telephone number. The server 110 may store an association between the phoneword and the business, e.g. in the data store 114. In block 320, the server 110 determines whether any additional telephone numbers of businesses associated with the selected category exist (e.g. of the telephone numbers retrieved in block 306), for which the blocks 310-318 have not been performed.

If, in block 320, the server 110 determines that additional telephone numbers exist, the server 110 moves to block 322. In block 322, the server 110 selects the next telephone number for which blocks 310-318 have not been performed (e.g. from the telephone numbers retrieved in block 306). The server 110 then repeats blocks 310-318 for the selected telephone number. If, in block 320, the server 110 determines that blocks 310-318 have been performed for all of the retrieved telephone numbers (e.g. in block 306), the server 110 moves to block 324. In block 324, the server 110 provides the phonewords associated with each of the businesses to each of the businesses, e.g. to electronic devices 102, 104, 106 being interacted with by users associated with the businesses.

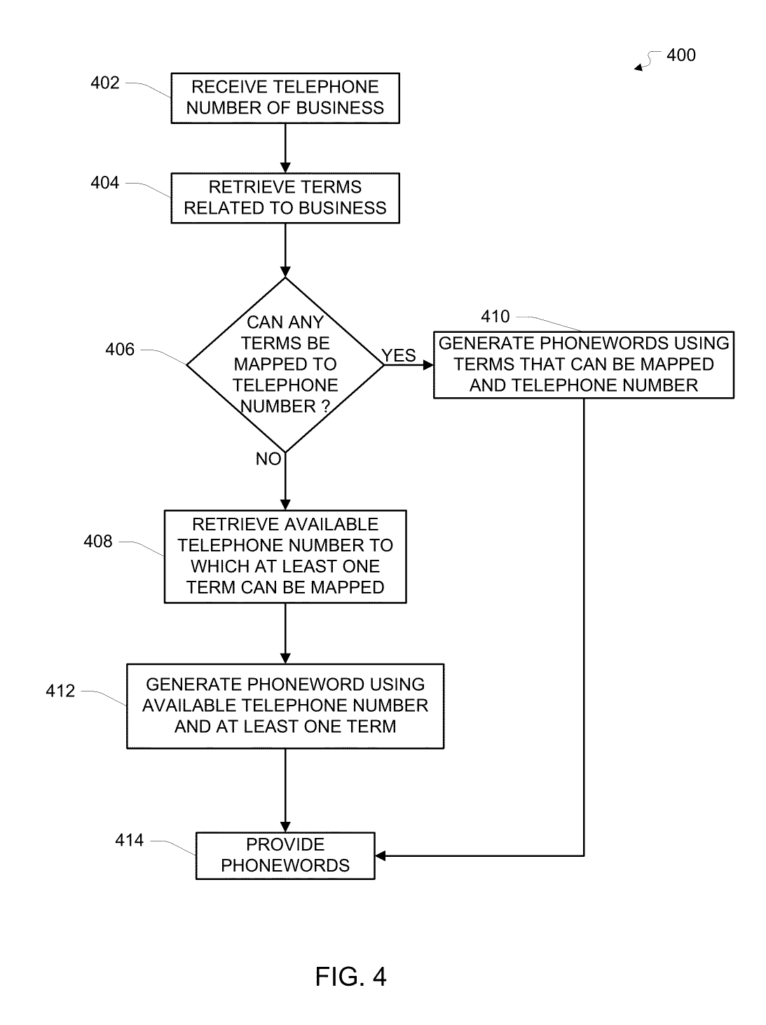

FIG. 4 illustrates a flow diagram of example process 400 for contextualized word to telephone number mapping in accordance with one or more implementations. For explanatory purposes, example process 400 is described herein with reference to example network environment 100 of FIG. 1; however, example process 400 is not limited to example network environment 100 of FIG. 1. Further for explanatory purposes, the blocks of example process 400 are described herein as occurring in serial, or linearly. However, multiple blocks of example process 400 may occur in parallel. In addition, the blocks of example process 400 need not be performed in the order shown and/or one or more of the blocks of example process 400 need not be performed.

In block 402, the server 110 receives a telephone number of a business. For example, a user that is associated with the business, such as an employee or owner of the business, may interact with the electronic device 102 to provide a telephone number of the business to the server 110. Alternatively, or in addition, the server 110 may retrieve the telephone number of the business from a third party server, e.g. over the network 108, or from a memory, such as the data store 114. In block 404, the server 110 determines terms that are related to the business. For example, the server 110 may determine terms related to a name of the business, an abbreviation of the name of the business, a description of the business, an online presence of the business, e.g. web pages, news feeds, etc., a category associated with the business, queries searched for by users that resulted in the users finding the business, terms for which the business has pursued online advertising, or generally any information related to the business that is determinable by the server 110.

In block 406, the server 110 determines whether any of the terms (e.g. retrieved in block 404) can be mapped to at least a portion of the telephone number of the business, e.g. based at least in part on an alphanumeric-to-numeric mapping of a telephone keypad. For example, a term may map to the entire telephone number, a starting portion of the telephone number, e.g. including the first ordered number of the telephone number but not the last ordered number, a middle portion of the telephone number, e.g. including neither the first or last ordered numbers of the telephone number, or an ending portion of the telephone number, e.g. including the last ordered number of the telephone number but not the first ordered number. If, in block 406, the server 110 determines that at least one of the retrieved terms (e.g. in block 404) can be mapped to the telephone number of the business, the server 110 moves to block 410.

In block 410, the server 110 generates one or more phonewords based at least in part on the telephone number of the business and the terms that can be mapped to the telephone number of the business. For example, the server 110 may generate a phoneword based at least in part on a term that can be mapped to the telephone number and the telephone number, e.g. by replacing numbers of the telephone number with the letters of the term that are mapped to the numbers. In block 414, the server 110 provides the phonewords, e.g. to an electronic device 102 being interacted with by a user that is associated with the business.

If, in block 406, the server 110 determines that none of the retrieved terms (e.g. in block 404) can be mapped to at least a portion of the telephone number of the business, the server 110 moves to block 408. In block 408, the server 110 retrieves an available telephone number to which at least one of the retrieved terms (e.g. in block 404) can be mapped. For example, the server 110 may have access to a list of available telephone number, such as stored in data store 114, or provided by a third party server. In block 412, the server 110 generates at least one phoneword based at least in part on the available telephone number and the at least one term that can be mapped to the available telephone number.

In block 414, the server 110 provides the at least one phoneword, e.g. to an electronic device 102 being interacted with by a user that is associated with the business. The server 110 may also provide an indication that the available telephone number can be procured by the business and/or a mechanism for the business to procure the available telephone number. For example, the server 110 may provide a user interface to the electronic device 102 being interacted with by the user associated with the business that allows the user to procure the available telephone number for the business.

IV. Example Alphanumeric-to-Numeric Mappings for Contextualized Word to Telephone Number Mapping Systems

FIG. 5 illustrates an example alphanumeric-to-numeric mapping 500 for a contextualized word to telephone number mapping system in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The example alphanumeric-to-numeric mapping 500 of FIG. 5 is representative of an example telephone keypad. In the example alphanumeric-to-numeric mapping 500, the alphanumeric character ‘1’ is mapped to the numeric ‘1’, the alphanumeric characters ‘a’, ‘b’, ‘c’, and ‘2’ are mapped to the numeric ‘2’, the alphanumeric characters ‘d’, ‘e’, ‘f’, and ‘3’ are mapped to the numeric ‘3’, the alphanumeric characters ‘g, ‘h’, ‘i’, and ‘4’ are mapped to the numeric ‘4’, the alphanumeric characters ‘j’, ‘k’, ‘l’, and ‘5’ are mapped to the numeric ‘5’, the alphanumeric characters ‘m’, ‘n’, ‘o’, and ‘6’ are mapped to the numeric ‘6’, the alphanumeric characters ‘p, ‘q’, ‘r’, ‘s’, and ‘7’ are mapped to the numeric ‘7’, the alphanumeric characters ‘t’, ‘u’, ‘v’, and ‘8’ are mapped to the numeric character ‘8’, the alphanumeric characters ‘w, ‘x’, ‘y’, ‘z’, and ‘9’ are mapped to the numeric character ‘9’, and the alphanumeric character ‘0’ is mapped to the numeric character ‘0’. As previously discussed, the alphanumeric-to-numeric mapping 500 may vary based at least in part on geographic regions, regional languages, regional alphanumeric characters, and/or regional numeric characters.

V. Example Contextualized Word to Telephone Number Mapping Systems

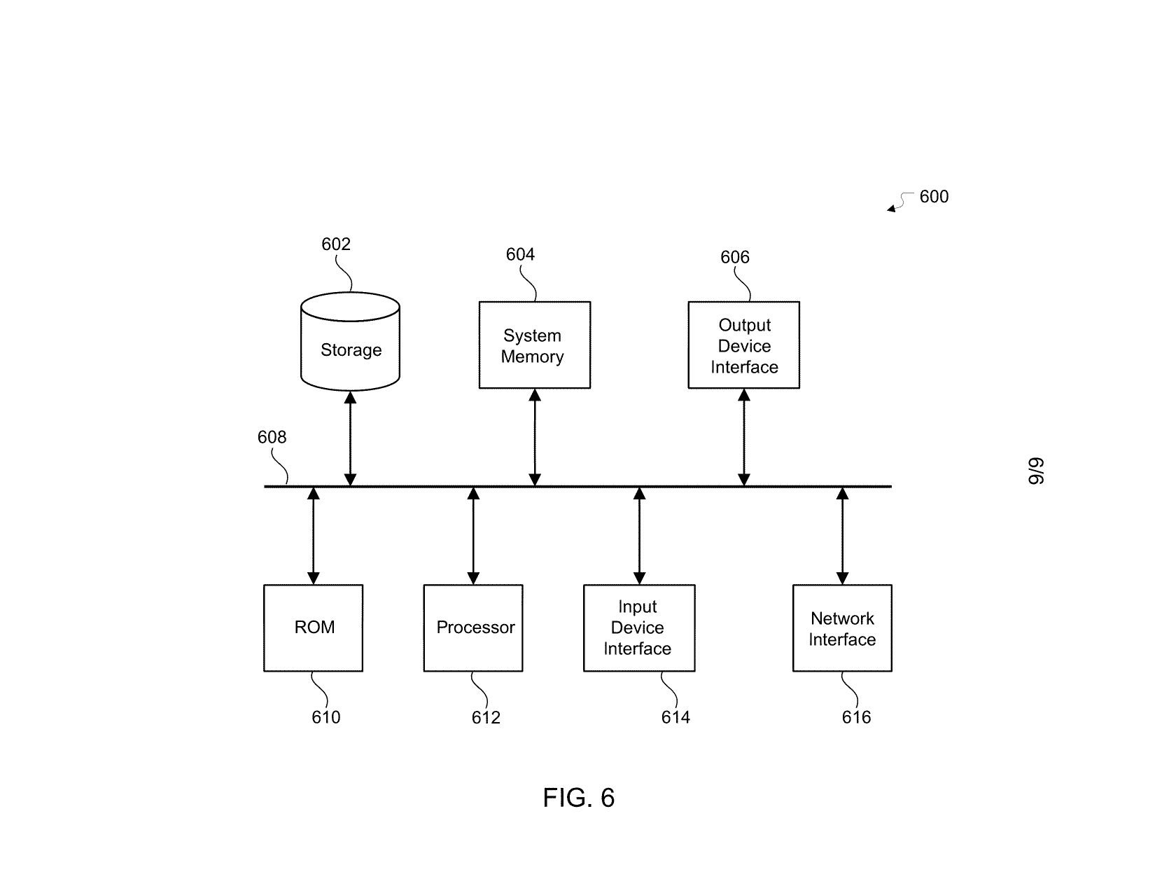

FIG. 6 conceptually illustrates electronic system 600 with which any implementations of the subject technology may be implemented. Electronic system 600, for example, can be a desktop computer, a laptop computer, a tablet computer, a server, a switch, a router, a base station, a receiver, a phone, a personal digital assistant (PDA), or generally any electronic device that transmits signals over a network. Such an electronic system includes various types of computer readable media and interfaces for various other types of computer readable media. Electronic system 600 includes bus 608, processing unit(s) 612, system memory 604, read-only memory (ROM) 610, permanent storage device 602, input device interface 614, output device interface 606, and network interface 616, or subsets and variations thereof.

Bus 608 collectively represents all system, peripheral, and chipset buses that communicatively connect the numerous internal devices of electronic system 600. In one or more implementations, bus 608 communicatively connects processing unit(s) 612 with ROM 610, system memory 604, and permanent storage device 602. From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. One or more implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such as random access memory. System memory 604 stores any of the instructions and data that processing unit(s) 612 needs at runtime. In one or more implementations, the processes of the subject disclosure are stored in system memory 604, permanent storage device 602, and/or ROM 610. From these various memory units, processing unit(s) 612 retrieves instructions to execute and data to process in order to execute the processes of one or more implementations.

Bus 608 also connects to input and output device interfaces 614 and 606. Input device interface 614 enables a user to communicate information and select commands to the electronic system. Input devices used with input device interface 614 include, for example, alphanumeric keyboards and pointing devices (also called “cursor control devices”). Output device interface 606 enables, for example, the display of images generated by electronic system 600. Output devices used with output device interface 606 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, bus 608 also couples electronic system 600 to a network (not shown) through network interface 616. In this manner, the computer can be a part of a network of computers (such as a local area network (“LAN”), a wide area network (“WAN”), or an Intranet, or a network of networks, such as the Internet. Any or all components of electronic system 600 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A computer-implemented method for determining contextually relevant terms that can be mapped to a telephone number of a business, the method comprising:
retrieving, using one or more computing devices, telephone numbers of businesses, each business being associated with a business category;
determining, using the one or more computing devices, a keyword that is associated with the business category, the keyword being distinct from names of the businesses;
determining, using the one or more computing devices and for each business, whether the keyword can be mapped to at least a portion of the telephone number of the business based at least in part on an alphanumeric-to-numeric mapping;
generating, using the one or more computing devices and for each business for which the keyword can be mapped to the at least the portion of the telephone number of the business, a phoneword for the business by replacing the at least the portion of telephone number of the business with the keyword; and
providing, using the one or more computing devices and to each business for which the keyword can be mapped to at least the portion of the telephone number of the business, the phoneword for the business.

2. The method of claim 1, further comprising:
receiving, using the one or more computing devices, an advertisement that comprises the telephone number of one of the businesses;
replacing, using the one or more computing devices, the telephone number of the one of the businesses in the advertisement with the phoneword for the one of the businesses; and
providing, using the one or more computing devices, the advertisement including the phoneword to a device of a user.

3. The method of claim 1, wherein the keyword comprises at least one of an acronym, an abbreviation, an alphanumeric combination, or at least a portion of a word.

4. A computer-implemented method for mapping a contextually relevant term to a telephone number, the method comprising:
receiving, using one or more computing devices, an ordered plurality of numbers that are associated with a business;
determining, using the one or more computing devices, a first category that is associated with the business;
determining, using the one or more computing devices, a first ordered plurality of alphanumeric characters that are related to the first category and that can be mapped to at least a first portion of the ordered plurality of numbers based at least in part on an alphanumeric-to-numeric mapping; and
providing, using the one or more computing devices, the first ordered plurality of alphanumeric characters.

5. The method of claim 4, further comprising:
determining, using the one or more computing devices, a second category that is associated with the business;
determining, using the one or more computing devices, a second ordered plurality of alphanumeric characters that are related to the second category and that can be mapped to at least a second portion of the ordered plurality of numbers based at least in part on the alphanumeric-to-numeric mapping; and
providing, using the one or more computing devices, the second ordered plurality of alphanumeric characters.

6. The method of claim 5, further comprising:
generating, using the one or more computing devices, a first phoneword based at least in part on the ordered plurality of numbers by replacing the at least the first portion of the ordered plurality of numbers with the first ordered plurality of alphanumeric characters based at least in part on the alphanumeric-to-numeric mapping;
generating, using the one or more computing devices, a second phoneword based at least in part on the ordered plurality of numbers by replacing the at least the second portion of the ordered plurality of numbers with the second ordered plurality of alphanumeric characters based at least in part on the alphanumeric-to-numeric mapping; and
providing, using the one or more computing devices, the first phoneword and the second phoneword.

7. The method of claim 6, wherein the ordered plurality of numbers that are associated with the business comprises a telephone number that is associated with the business.

8. The method of claim 7, further comprising:
receiving, using the one or more computing devices, a request for an advertisement, wherein the request comprises a third category;
retrieving, using the one or more computing devices and based at least in part on the request, an advertisement for the business that comprises the telephone number that is associated with the business;
replacing, using the one or more computing devices, the telephone number in the advertisement with the first phoneword when the third category of the request comprises the first category and replacing the telephone number in the advertisement with the second phoneword when the third category of the request comprises the second category; and
providing, using the one or more computing devices, the advertisement.

9. The method of claim 8, wherein the first portion of the ordered plurality of numbers shares at least one number in common with the second portion of the ordered plurality of numbers.

10. The method of claim 8, wherein the alphanumeric-to-numeric mapping is based at least in part on a mapping of alphanumeric characters to numbers on a telephone keypad used in a geographic region that is associated with at least one of the request or the telephone number of the business.

11. The method of claim 4, wherein the ordered plurality of alphanumeric characters comprises at least one of a keyword, an acronym, an abbreviation, or an alphanumeric combination.

12. A non-transitory machine readable medium embodying instructions that, when executed by a machine, cause the machine to perform a method for determining contextually relevant terms that can be mapped to a telephone number of a business, the method comprising:
determining a telephone number of a business and a plurality of candidate terms that are contextually relevant to the business, wherein the telephone number comprises an ordered plurality of numbers;
determining a plurality of terms of the plurality of candidate terms that can be mapped to at least a portion of the ordered plurality of numbers of the telephone number based at least in part on an alphanumeric-to-numeric mapping;
generating a plurality of phonewords using the plurality of terms and the telephone number, wherein each of the plurality of phonewords comprises the telephone number with the at least the portion of the ordered plurality of numbers being replaced with one of the plurality of terms; and
providing the plurality of phonewords to a device of a user associated with the business.

13. The non-transitory machine readable medium of claim 12, wherein a first term of the plurality of terms is mapped to a first portion of the ordered plurality of numbers and a second term of the plurality of terms is mapped to a second portion of the ordered plurality of numbers, the first term being distinct from the second term.

14. The non-transitory machine readable medium of claim 13, wherein the first portion of the ordered plurality of numbers is distinct from the second portion of the ordered plurality of numbers.

15. The non-transitory machine readable medium of claim 12, further comprising:
determining the alphanumeric-to-numeric mapping based at least in part on a geographic region associated with the telephone number.

16. The non-transitory machine readable medium of claim 12, further comprising:
receiving a search query;
retrieving, based at least in part on the search query, an advertisement for the business that comprises the telephone number of the business;
replacing the telephone number in the advertisement with one of the plurality of phonewords; and
providing the advertisement including the one of the plurality of phonewords.

17. The non-transitory machine readable medium of claim 12, wherein at least one of the plurality of terms comprises an acronym, an abbreviation, an alphanumeric combination, or at least a portion of a word.

18. A system, comprising:
one or more computing devices; and
a memory including instructions that, when executed by the one or more computing devices, cause the one or more computing devices to:
receive a telephone number of a business and a plurality of terms related to the business;
determine whether at least one of the plurality of terms can be mapped to the telephone number of the business based at least in part on an alphanumeric-to-numeric mapping; and
provide the at least one of the plurality of terms when the at least one of the plurality of terms can be mapped to the telephone number of the business, otherwise provide an available telephone number to which the at least one of the plurality of terms can be mapped using the alphanumeric-to-numeric mapping.

19. The system of claim 18, wherein the available telephone number comprises a common area code as the telephone number or an area code that is associated with a geographic region that is associated with the telephone number.

20. The system of claim 18, wherein the memory further includes instructions that, when executed by the one or more computing devices, cause the one or more computing devices to:
determine the alphanumeric-to-numeric mapping based at least in part on a geographic region associated with the telephone number.
